(19) United States
(12) Patent Application Publication
(10) Pub. No.: US 2001/0027953 A1
(43) Pub. Date: Oct. 11, 2001

(54) Automated reclamation system

(76) Inventor: Robert L. Smith, Middleboro, MA (US)

Correspondence Address: CESARI AND MCKENNA, LLP, 88 BLACK FALCON AVENUE, BOSTON, MA, 02210, US

(21) Appl. No.: 09/793,275

(22) Filed: Feb. 26, 2001

Related U.S. Application Data
(60) Provisional application No. 60/184,620, filed on Feb. 24, 2000.

(51) Int. Cl. C02F 1/68

(52) U.S. Cl. 210/749; 210/97; 210/198.1

(57) ABSTRACT

A device for sequential automatic introduction of additives to an impure serous fluid causing precipitates to be formed. The precipitates serve to segregate the bulk of the impurities from the stream allowing reclamation of the remaining fluid. The additives are fed by automated pumps and/or valves correlated by a microprocessor-based controller that measures the results from each of the sequential operations and determines to re-cycle the flow or deliver the flow to a separation system. The microprocessor controller oversees and controls the system operations. Multiple sensors, additive pumps, pumps, valves, timers, delay time calculations between physical location in the system, flow meters, pH meters and other such sensors are arranged sequentially to monitor the process parameters and deliver a desired volume of additives to meet process requirements for balancing and reclamation of the resulting flow.

### RELATED APPLICATIONS

This application claims priority from a Provisional Patent application of the same title, inventorship, and ownership as the present application. This provisional application was filed on Feb. 24, 2000, and bears the Ser. No. 60/184,620. This Provisional application is hereby incorporated herein by reference.

### BACKGROUND OF THE INVENTION

1. Field of the Invention

The present invention relates generally to fluid systems, which deliver multiple mixtures of additives to separate impurities from a serous stream. The invention has particular application in automating systems for the controlled delivery of additives intended to remove impurities from a stream and allow reclamation of the majority of the serous stream.

2. Background Information

In many industries there is a need to treat a process waste fluid stream to remove impurities and allow the disposal or reclamation of the primary process fluid (medium). These process waste or contaminated streams contain components that contaminate publicly owned treatment works (POTW) waste streams and components that inhibit the recovery and re-use of the primary process fluid of the waste stream. Furthermore, these process waste streams are regulated by the EPA (Environmental Protection Agency) regarding allowable content for discharge into public environments and are often subject to provisional fees for such discharge.

FIG. 1 illustrates a prior art system for recovery of components in a waste stream 6. This system pumps chemical additives 2, 2′, and 2″ into sequential stationary vessels 4 through which the waste stream 6 flows. The mixture is stirred (blended) with mechanical driven propeller type mixers 8 in each vessel to amalgamate the fluid to produce precipitates. The slurry blend then flows 10 to another process point where the precipitates are separated as well as possible from the primary process fluid.

The chemical additives 10, 10′, and 10″ used in the system of FIG. 1 are manually adjusted for the particular component contaminants and their proportions in the incoming process waste stream 6. In these systems adjustments are not made until someone notices that the process is “out of balance.” The congruity of this separation is directly affected by the accuracy and appropriateness of each previous chemical addition for the process stream at a particular moment in time. Processes are considered “out of balance” when the anticipated chemical reactions are either not taking place or are different than expected. These out of balance conditions can be caused by many factors, including changes in the incoming flow (content, pH, temperature, etc.), changes in the additive flow (flow rate, content, pH, temperature, etc.) or other such factors such as failure in a process component due to mechanical problems or human intervention. These “out of balance” conditions in most existing systems are normally detected by visual means. For instance the operator notices that the expected flow clarity is not present.

Large changes in the incoming process waste stream 6 are not well handled in these manual systems, and thus the systems become “out of balance” and inefficient, and the fluid output is not suitable and must be treated again. For this reason the purity of the output process stream cannot be guaranteed suitable for reclamation and most generally must be discharged.

A problem is these prior art systems occur when large changes in the incoming waste flow stream are undetected and enter and contaminate the subsequent reclamation process.

In the industrial laundry industry, for example, current water treatment procedures generally involve sending a wash process waste stream through sequential stationary tanks where chemicals are added and stirred mechanically similarly to the system of FIG 1. The amount of chemical additive to be added at each tank is determined beforehand by manual bench testing and set to feed according to an expected waste water stream flow rate and composition. From these tanks the treated flow proceeds to a clarification device where the precipitates separate from the main flow. In general the quality of the resulting flow allows it to be released directly into the public sewer with only a small or no additional surcharge fees. A few industrial laundry plants using these prior art systems are able to consistently reuse some small percentage of the treated water, but only for wash classifications such as walk off mats, shop towels, inker towels, etc. where water and cleaning quality issues, such as re-deposition, are not critical.

One prior art method used to counteract these limitations is a system based on batch processing. In these systems a quantity of the waste stream is collected and stored in batches. Each batch content is manually analyzed to determine the correct additive parameters that are then used to treat the batch. However, such systems are labor intensive and are often not time efficient.

Another prior art system is shown in U.S. Pat. No. 5,246,590. (Dobrez et al.) that discloses use of a controller and a sensor. The process uses a cumulative dosing level of a cationic coagulant that is manually obtained over a period of up to a week. The cationic coagulant reduces FOG concentrations specific to industrial laundry applications. A streaming current detector (sensor) is monitored in a side stream. Appropriate values are then manually entered into a controller, which uses these values to operate a dosing pump to introduce proper dosing levels according to the detector measurements. No provisions are included to detect large changes in the incoming waste stream, nor are there any provisions to divert the treated stream if the dosing levels cannot be met. The clarified aqueous phase or water from this prior art system is intended solely for discharge to a publicly owned treatment works for further processing. No waste component recovery or re-use of the water is suggested.

It is an object of the present invention to address the limitations of these prior art systems.

### SUMMARY OF THE INVENTION

This invention addresses the aforementioned prior art shortcomings by using microprocessor monitoring and precision adjustment of multiple processor parameter characteristics in a serous fluid flow before the process becomes synergistically unbalanced. Changes in the incoming process waste stream and in the internal reclamation process stream are continuously and automatically detected by the controller, thereby allowing a flexible feedback system to provide a not “out of balance” output steam. The present system provide flow meters and other sensors, for example pH, other such specific ion sensors, and temperature, pressure and the like, to be placed in the system flows at known locations and distances relative to the other elements of the inventive method and system. This allows the controller to compensate for the lag times between the sensors and the locations where additives are injected into the flow via pumps and valves in a real time manner. This provides for an early warning feature built in to the system. For example, the early warning allows the controller to detect any change in a flow stream and make adjustments before it enters the system or the next system element. Any change at any point along the processing sequence is monitored the additives are automatically adjusted to compensate for the changes without over or under dosing as in prior art systems. An embodiment of the present invention provides for specific proportions of the various chemical additives that enhances efficiency, performance, repeatability and that reduces cost. This feature also allows the microprocessor controller to detect anomalies in the expected incoming stream and feed balancing additives into the flow thereby reducing the possibility of premature failure in the process due to unexpected changes. The controller also monitors additive availability. This feature allows a controlled system shut down sequence to occur before an out of balance condition due to additive unavailability causes contamination of the reclamation process.

### BRIEF DESCRIPTION OF THE DRAWINGS

The invention description below refers to the accompanying drawings, of which:

FIG. 1 is a diagram of a typical prior art system;

FIG. 2 is a block/flow/control schematic diagram of a preferred embodiment automated continues flow fluid reclamation system;

FIG. 3 is a block/flow/control schematic diagram of a preferred embodiment automated batch fluid reclamation system;

FIG. 4 is a block/flow/control schematic diagram of a preferred embodiment automated batch plating fluid reclamation system; and

FIG. 5 is a block/flow/control schematic diagram of a preferred embodiment automated fluid reclamation system.

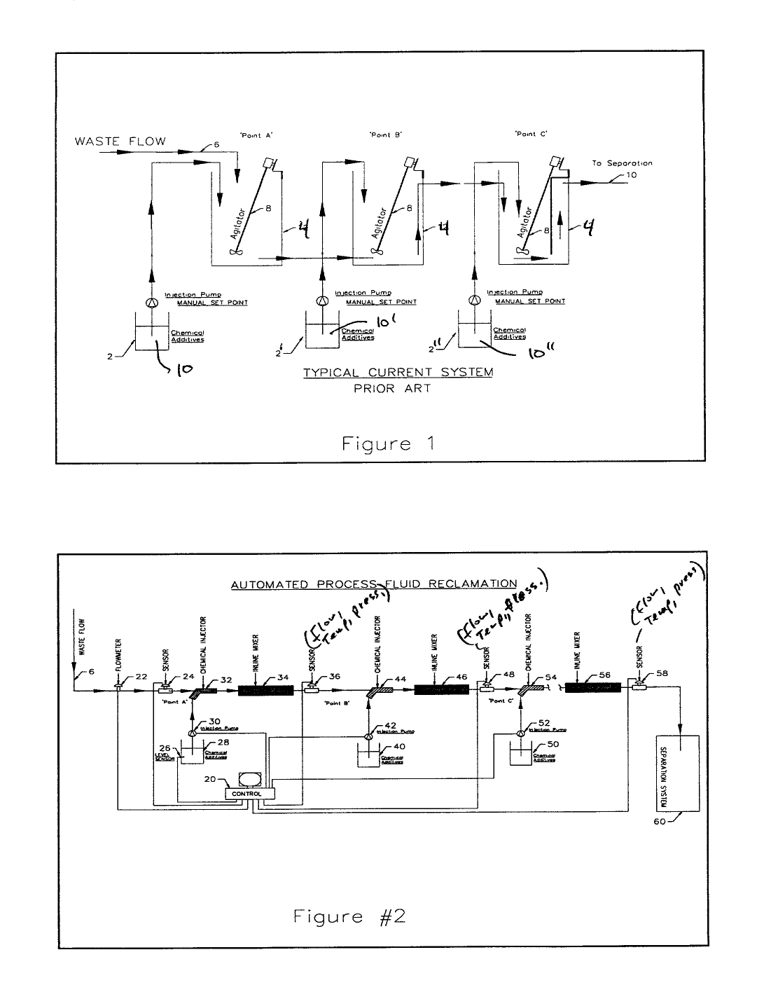

### DETAILED DESCRIPTION OF ILLUSTRATIVE EMBODIMENTS

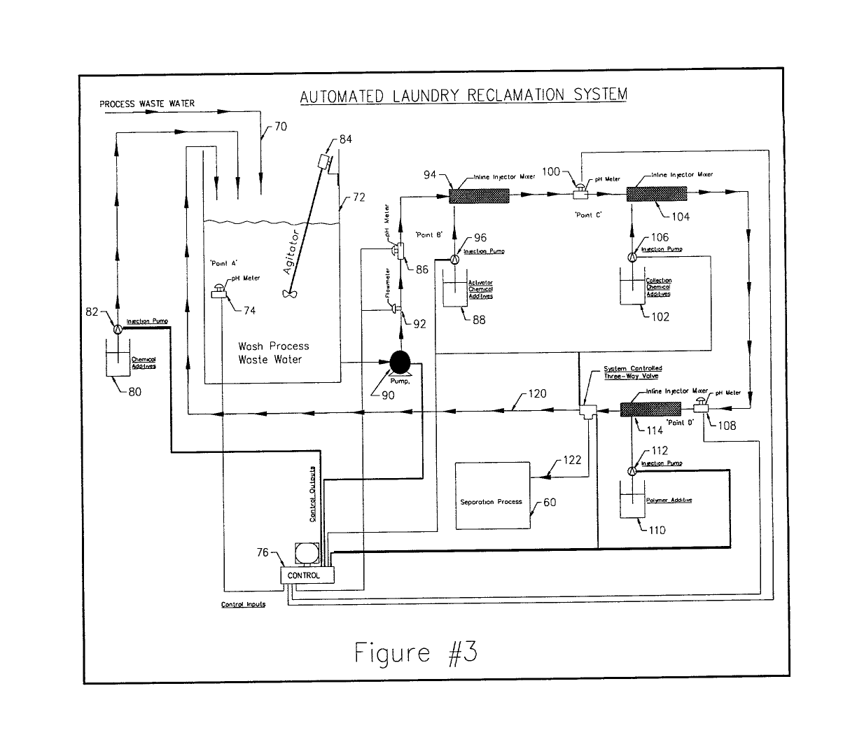

FIG. 2 shows a preferred embodiment of the inventive system where a computer 20 controls the process. A flow meter 22 and a sensor 24 monitor two parameters of the incoming waste flow stream 6. The flow meter 22 and the other flow meters described below are placed at known specific distances relative to the other elements (meters, tanks, etc.) along the system that allows the controller to calculate the transport lag throughout the system including between injecting an additive and sensing the response. When the controller reads the sensor 24 it calculates the amount of additive to be injected into the flow stream. The controller may measure 26 the amount of additive in the container 28, and, via the injector pump 30 feeding the injector valve 32, a calculated volume of additive is added that will cause a desired sensor reading on the flow sensor 36 placed in flow exiting the mixer 34. The controller having the flow rate sensed by the sensor 34 may inject from container 40 via the pump 42 and the injector valve 44 an additive that is mixed 46 into the flow. Another sensor 48, container 50, pump 52 and mixer 54 provides a means for adding more of another or the same additive which is mixed 56 into the flow stream. A final sensor 58 measures the exiting flow. If acceptable, the flow is fed to a separator system and if not acceptable the flow may be directed by the controller into a retaining equalization tank or vessel or re-circulated (not shown). This assures that no unacceptable effluent is delivered from the system.

By using computer controlled multiple injection mixers and sensors as shown in FIG. 2 for homogeneous blending, the system uses fewer additives and can control and provide a reaction equilibrium at each injection point. The flow stream is monitored as it approaches and leaves each mixer allowing the processor to detect and compensate for any changes. Other sensors may include temperature and pressure sensors that may detect abnormal reactions and blockages that will cause system failures.

The system may include a start up feature (not shown) that automatically returns the process stream to equalization tanks (mentioned above) or to the source stream for a period of predetermined time so that no contamination occurs to the subsequent clarification process by fluid that does not meet the quality standards as programmed into the control system.

The system is dependent on the microprocessor and the in-line sensors in combination with the multiple mixers and injectors to maintain a homogeneous balance that will precipitate the impurities out of the process stream in the separation system 60. When used for a wastewater process, the system is programmed to render the water for reuse or can be discharged to waste (sewer).

Embodiments of the invention may be adapted to many different types of waste streams. Also, the processing element and other components may be made from different materials depending upon the applications. For example, stainless steel, black iron, A.B.S. plastic, and PVC (polyvinylcholride). Embodimets of the invention accommodate fluid flows from 10 GPM (gallons per minute) to 300 GPM. When extended in a modular fashion of more and/or different additive/metering/injection/mixers stations, embodiments of the invention may be applied to most any flow requirement.

The combination of early warning sensors, non-fouling in-line mixers, multiple injection points and a microprocessor-based controller that oversees and controls the system's operation while monitoring multiple sensors throughout the system provide advantages in waste stream reclamation.

### EXAMPLE 1

The present invention as configured as shown in FIG. 3 addresses the specific issues of water reclamation from the industrial laundry industry. Waste or contaminated water 70 coming from a wash process waste stream is contained in a vessel 72 where the water pH is monitored 74 and sent to a microprocessor controller 76. At system startup, the microprocessor controller turns on the process pump 90, monitors the water flow rate 82 and the pH 84. The system is capable of causing a pH balancing chemical 80 to be injected 82 and mixed 84 to insure stable chemistry at the first portion of the system, if needed. The resultant pH is then measured 86 and the microprocessor 76, in response to the measured pH, may inject 96 an activator chemical, such as Poly Aluminum Chloride (PAC), Ferrous Chloride, Ferric Chloride or HCL, for example, that is mixed 94 at a rate controlled by the microprocessor to reach a desired pH range. The resultant pH measurement 100 is a target value (such as 5.5 pH) set by the microprocessor designed to destroy the chemical binding of the surfactants and emulsifiers present in laundry waste water.

The system continues where the microprocessor utilizes the pH measurement 100 to inject 106 and mix 104 a reactor collection chemical 102, if necessary, such as sodium hydroxide at a rate designed to reach a calculated pH range as measured by the pH meter 108. This resultant pH measurement is a target value (such as 10.5 pH) set by the microprocessor designed to create a chemical binding of the contaminates and the activator chemical present in the waste water stream.

The microprocessor utilizes the pH measurement 108, the waste water stream flow rate 92, the volume of previously injected chemicals, and other pertinent information to calculate, inject 112 and mix 114 a polymer flocculating chemical 110 at a rate designed to gather together all contaminates and chemicals present in the stream. At this point the microprocessor examines all operations parameters and decides if the stream returns 120 to the original storage point to be recycled or if adequately treated diverts the stream 122 to a separation and clarification device 60. The real time ability of the microprocessor to simultaneously monitor process parameters, calculate balanced reactions, control injections and homogeneously blend the industrial wash process waste stream delivers reclaimed water of a quantity suitable for use on many wash process classifications without risk of redeposition. Typically 50%-80% of the original incoming water may be recovered for reuse by this process.

### EXAMPLE 2

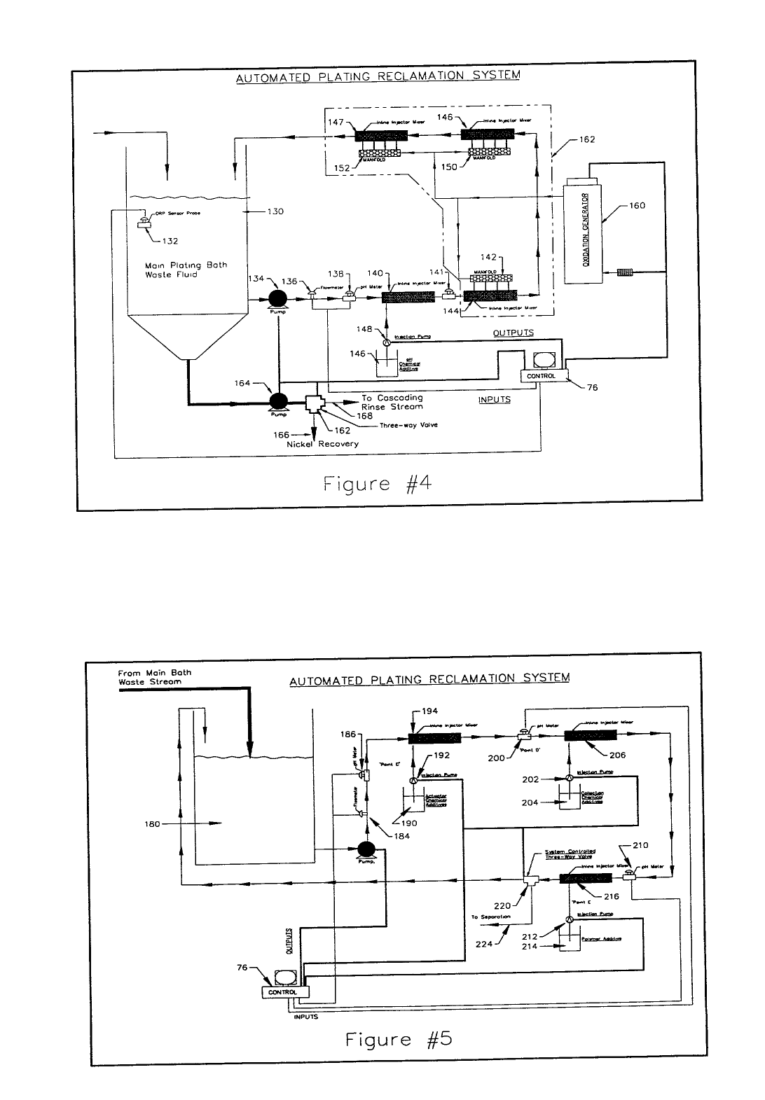

In the plating industry, the waste stream generated contains metals which are considered a contaminant and cannot be discharged without treatment. One such plating process generates nickel sulfamate. In a main plating bath of one hundred gallons, the solution generally contains eight ounces of nickel per gallon or fifty pounds of recoverable material. The cascading rinses from the process also contain nickel but in a much smaller concentration. FIG. 4 shows the operation of the present invention to such an operation. The main plating bath 130 would be pumped into the pre-treat sections as described. The main plating bath waste stream is monitored for its pH 138 which is used as an initial reference value. At system startup, the microprocessor controller 76 turns on the batch process pump 134, monitors the flow rate 136, calculates, injects 148 and mixes 140 a caustic from a container 146 at a rate calculated to drive the resultant pH value into the range of 10.0 to 11.5 pH. This resultant pH 132 sensor measurement is a target value (such as 10.5 pH) set by the microprocessor that will destroy the chemical binding present in the main plating bath. The waste stream is then sent to an oxidation flow loop 162. In the oxidation flow loop, the controller circulates the liquid through self cleaning inline mixers 144, 146 and 148 where a high potential oxidizing gas is injected and mixed. The gas is formed in a vessel 160 and injected into the in-line mixers 144, 146 and 148 via the manifolds 142, 150 and 152. The controller monitors the ORP (oxidation reduction potential) sensor 132 to determine sufficient exposure time to the high potential oxidizing gas. Oxidation at a high pH causes the Nickel to drop out of solution allowing it to be recovered 166. The remaining batch liquid is then pumped into the stream of cascading rinses 168 where it undergoes further treatment. See FIG. 5.

With reference to FIG. 5, water coming from the stream of cascading rinses 168 is collected 180 and monitored by the microprocessor controller for its pH reference value 186. At system startup, the microprocessor controller turns on the cascading rinses stream process pump 182 and monitors the water flow rate 184.

In response to the reference pH, the microprocessor controller may inject 192 an activator chemical 190 such as Poly Aluminum Chloride (PAC), Ferrous Chloride, Ferric Chloride or HCL. The activator chemical is mixed 194 with the flow stream at a rate controlled by the microprocessor to reach a calculated pH range of 6.0 pH at pH meter 200. This pH value will destroy the chemical binding present in the rinse waste water.

The microprocessor controller, in response to the pH meter 200 will inject 202, mix 206 a suitable reactor collection chemical, such as sodium hydroxide, from the vessel 204 at a rate designed to reach a calculated pH of 10.5 which will create a chemical binding of the contaminates and the activator chemical present in the waste water stream.

The microprocessor controller measures the resulting pH 210, and, knowing the waste water stream flow rate, the volume of previously injected chemicals and other pertinent information, calculates and injects 212 and mixes 216 a polymer flocculating chemical 214 at a rate designed to gather together for removal of all contaminates and chemicals present in the stream. At this point the microprocessor controller determines if the stream returns 222 to the original storage point to be redone or if adequately treated diverts 224 the stream to a clarification divice. The real time ability of the system to simultaneously monitor process parameters, calculate balanced reactions, control injections and homogeneously blend the industrial process waste stream allows the system to deliver reclaimed water of a quality suitable for use in the initial main plating bath.

The preferred embodiments above are specific examples where the flow rates, distances between the system elements, and the volumes are known. In these system and other systems where these parameters are known, the microprocessor controller system will factor in the lag times between when an additive is added an what the results can be measured. Control systems with such delay or lag times are well known in the art, and application of these known techniques allows the inventive control systems to converge and provide the desired reclamation results.

What is claimed is:

1. A contaminated fluid flow treatment system comprising:
a first flow meter that measures the flow rate of the contaminated fluid flow,
a container of a first additive, wherein the first additive is suitable for performing a first treating of the contaminated fluid flow,
a pump that delivers the first additive,
a first mixer that receives the contaminated fluid flow and the first additive,
a second flow meter that measure the fluid flow output of the first mixer,
a controller arranged to control the pumping and to receive the flow rate of the first and the second flow meters,
in response to the received first and second flow rates, a program executed by the controller determines a first quantity of the first additive suitable for treating the contaminated fluid flow, and wherein the program determines from the first flow rate and the quantity of the first additive a targeted second flow rate,
means for pumping the first quantity of the first additive into the contaminated fluid flow, wherein the program senses and compares the actual second flow rate and the targeted second flow rate.

2. The contaminated fluid flow treatment system as defined in claim 1 further comprising:
a fluid switch controlled by the computer executing the program, wherein the fluid switch receives the fluid output from the first mixer, and wherein the fluid switch has a first output that delivers the flow to a reclamation system and a second output that delivers the flow back into the contaminated fluid flow or into a holding container,
a threshold of the difference between the actual and the targeting second flow rates, wherein when the difference is below the threshold the program causes the switch delivers the flow to its first output, and when the difference exceeds the threshold the switch delivers to its second output.

3. The contaminated fluid flow treatment system as defined in claim 1 further comprising
a second container of a second additive, wherein the second additive performs a second treating of the contaminated fluid flow,
a second mixer that receives the fluid flow output from the first mixer and the second additive,
a third flow meter that measures the flow rate out of the second mixer,
a controller arranged to control the pumping and to receive the flow rate output from the second and the third flow meters,
in response to the received second and third flow rates, a program when executed by the controller determines a second quantity of the second additive suitable for treating the contaminated fluid flow, and wherein the program determines from the second flow rate and the quantity of the second additive a targeted third flow rate,
means for pumping the second quantity of the second additive into the contaminated fluid flow, wherein the program senses and compares the actual third flow rate and the targeted third flow rate.

4. The contaminated fluid flow treatment system as defined in claim 3 further comprising:
a second fluid switch controlled by the computer executing the program, wherein the fluid switch receives the output of the second mixer, and wherein the second fluid switch has a first output that delivers the flow to a reclamation system and a second output that delivers the flow back into the contaminated fluid flow or into a holding container,
a second threshold of the difference between the actual and the targeting third flow rates, wherein when the difference is below the second threshold the program causes the switch to deliver the flow to its first output, and when the difference exceeds the second threshold the switch delivers to its second output.

5. The contaminated fluid flow treatment system as defined in claim 3 further comprising a third container of a third additive, wherein the third additive performs a third treating of the contaminated fluid flow,
a third mixer that receives the fluid flow output from the second mixer and the third additive,
a fourth flow meter that measures the flow rate out of the third mixer,
the controller arranged to control the pump and to receive the flow rate output from the third and the fourth flow meters, in response to the received third and fourth flow rates, the program when executed by the controller determines a third quantity of the third additive suitable for treating the contaminated fluid flow, and wherein the program determines from the third flow rate and the quantity of the third additive a targeted fourth flow rate,
means for pumping the third quantity of the third additive into the contaminated fluid flow, wherein the program senses and compares the actual fourth flow rate and the targeted fourth flow rate.

6. The contaminated fluid flow treatment system as defined in claim 5 further comprising:
a third fluid switch controlled by the computer executing the program, wherein the third fluid switch receives the output of the third mixer, and wherein the third fluid switch has a first output that delivers the flow to a reclamation system and a second output that delivers the flow back into the contaminated fluid flow or into a holding container,
a third threshold of the difference between the actual and the targeting third flow rates, wherein when the difference is below the threshold the switch delivers the flow to its first output, and when the difference exceeds the threshold the switch delivers to its second output.

7. The contaminated fluid flow treating system as defined in claims 1, 3 or 5 further comprising a pH meter place in at least one fluid flow, and means for delivering the pH meter's output to the computer, and wherein the program adjusts the quantity of additive to be delivered with respect to the pH meters outputs.

8. The contaminated fluid flow treating system as defined in claims 7 further comprising a temperature or pressure or other specific ion detectors in at least one fluid flow, and means for delivering the detectors' outputs to the computer, and wherein the program adjusts the quantity of additive to be delivered with respect to the detectors' outputs.

9. The system as defined in claims 1, 3 and 5 further comprising:
means for calculating the delay time between the injecting of quantities of additives and the received subsequent flow rates, wherein the calculation uses the flow rate and the physical distances from the injection points and the sensors, and wherein the quantities of the additives are determined such that the resulting flow after the additives are injected is more in balance than before the additives were injected.

10. A contaminated fluid flow treatment method comprising the steps of:
measuring the flow rate of the contaminated fluid flow,
pumping a first additive into the contaminated fluid flow,
mixing the contaminated fluid flow and the first additive,
measuring the fluid flow after the mixing,
in response to the measured first and second flow rates, determining a first quantity of the first additive suitable for treating the contaminated fluid flow, and
determining from the first flow rate and the first quantity a targeted second flow rate,
pumping the first quantity into the contaminated fluid flow, and comparing the resulting second flow rate and the targeted second flow rate.

11. The contaminated fluid flow treatment method as defined in claim 1 further comprising the steps of
thresholding the difference from the comparing step, and
diverting the second flow to a reclamation system when the threshold is met, and to a holding container or back to the contaminated flow when not,

12. The contaminated fluid flow treatment method defined in claim 1 further comprising the steps of:
pumping a second additive into the fluid flow from the first mixing,
mixing the fluid flow and the second additive,
measuring the resulting fluid flow
in response to the measured first and second flow rates, determining a first quantity of the first additive suitable for treating the contaminated fluid flow, and
determining from the first flow rate and the first quantity a targeted second flow rate,
pumping the first quantity into the contaminated fluid flow, and
comparing the resulting second flow rate and the targeted second flow rate.

13. The contaminated fluid flow treatment system as defined in claim 12 further comprising the steps of:
thresholding the difference from the comparing step of claim 12, and
diverting the second flow to a reclamation system when the threshold is met, and when not to a holding container or back to the contaminated flow or back to the fluid flow from the first mixing.

14. The contaminated fluid flow treatment method as defined in claim 13 further comprising the steps of”
pumping a third additive into the fluid flow from the second mixing,
mixing the fluid flow from the second mixing and the second additive,
measuring the resulting fluid flow
response to the measured second and third flow rates, determining a second quantity of the second additive suitable for treating the contaminated fluid flow, and
determining from the second flow rate and the second quantity a targeted third-flow rate,
pumping the second quantity into the fluid flow from the second mixing, and
comparing the resulting third flow rate and the targeted third flow rate.

15. The contaminated fluid flow treatment method as defined in claim 5 further comprising the steps of:
thresholding the difference from the comparing step of claim 14, and
diverting the fluid flow from the third mixing to a reclamation system when the threshold is met, and when not to a holding container or back to the contaminated fluid flow or back to the fluid flow from the second mixing.

16. The contaminated fluid flow treating method as defined in claims 10, 12 or 14 further comprising the steps of:
measuring the pH in at least one fluid flow,
delivering the pH to the computer, and
adjusting the quantity of additive to be delivered with respect to the pH.

17. The contaminated fluid flow treating method as defined in claims 16 further comprising the steps of:
measuring a temperature or pressure or other specific ion in at least one fluid flow,
delivering the measurements to the computer, and
adjusting the quantity of additives to be delivered with respect to the measurements

18. The system as defined in claims 10, 12 and 14 further comprising the steps of:
calculating the delay time between the injecting of quantities of additives and the received subsequent flow rates, wherein the calculation uses the flow rate and the physical distances from the injection points and the sensors, and
determining the quantities of the additives such that the resulting flow after the additives are injected is more in balance than before the additives were injected.
